(19) United States
(12) Patent Application Publication
(10) Pub. No.: US 2026/0368098 A1
(43) Pub. Date: Nov. 19, 2026

(54) BANDWIDTH-BASED EVICTION OF DATA FOR A SYSTEM CACHE

(71) Applicant: QUALCOMM Incorporated, San Diego, CA (US)

(72) Inventors: Jian Shen, San Diego, CA (US); Jamie Menjay Lin, San Diego, CA (US)

(21) Appl. No.: 19/209,187

(22) Filed: May 15, 2025

(51) Int. Cl. G06F 12/0891; G06F 12/126; G06F 13/16

(52) U.S. Cl. CPC G06F 12/0891; G06F 12/126; G06F 13/1678

(57) ABSTRACT

An apparatus includes a system cache and a cache controller coupled to the system cache. The system cache is configured to store first data associated with a first producer and a neural signal processor (NSP). The system cache is further configured to store second data associated with a second producer and the NSP. The cache controller is configured to evict one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

### TECHNICAL FIELD

Aspects of the present disclosure relate generally to integrated circuits, and more particularly, to caching of data for integrated circuits.

### INTRODUCTION

Electronic devices increasingly perform a variety of functions for users. For example, in addition to supporting voice calls, a mobile device (such as a smart phone) may support a variety of other operations and may include a variety of electronic components to support these operations. The operations may include, for example, image and video capture, health monitoring and activity tracking, wireless local area network (WLAN) communications, personal area network (PAN) communications, satellite communications, and other features. As another example, a vehicle may support wireless communications, navigation, and other driver assistance features such as adaptive cruise control, lane change assistance, collision avoidance, night vision, parking assistance, blind spot detection, lane keeping assistance, automated braking, partially autonomous driving, and fully autonomous driving.

To facilitate such a wide range of operations, memory devices are used to enable storage and retrieval of data. One example of a memory device is a dynamic random access memory (DRAM) device. A DRAM device may include volatile storage elements that facilitate relatively fast storage and retrieval of data. For example, in some systems, an integrated circuit may include one or more processors that store data to, and retrieve data from, a DRAM device that is coupled to the integrated circuit. Access to the DRAM may be limited due to latency, bandwidth constraints, or power consumption, which may be problematic in some scenarios.

### SUMMARY

The systems, methods and devices of this disclosure each have several innovative aspects, no single one of which is solely responsible for the desirable attributes disclosed herein.

In some aspects, an apparatus includes a system cache and a cache controller coupled to the system cache. The system cache is configured to store first data associated with a first producer and a neural signal processor (NSP). The system cache is further configured to store second data associated with a second producer and the NSP. The cache controller is configured to evict one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

In some further aspects, a method of operating a cache controller includes storing, to a system cache, first data associated with a first producer and a neural signal processor (NSP). The method further includes storing, to the system cache, second data associated with a second producer and the NSP. The method further includes evicting, from the system cache, one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

In some additional aspects, a non-transitory computer-readable medium stores instructions executable by one or more processors to initiate, perform, or control operations associated with a cache controller. The operations include storing, to a system cache, first data associated with a first producer and a neural signal processor (NSP). The operations further include storing, to the system cache, second data associated with a second producer and the NSP. The operations further include evicting one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating an example of a system-on-chip (SoC) that supports bandwidth-based eviction of data for a system cache.

FIG. 2 is a block diagram illustrating an example of a wireless device that supports bandwidth-based eviction of data for a system cache.

FIG. 3 is a block diagram illustrating an example of a system that supports bandwidth-based eviction of data for a system cache.

FIG. 4 is a block diagram illustrating another example of a system that supports bandwidth-based eviction of data for a system cache.

FIG. 5 is a flow chart illustrating an example of a method that supports bandwidth-based eviction of data for a system cache.

FIG. 6 is a flow chart illustrating another example of a method that supports bandwidth-based eviction of data for a system cache.

Like reference numbers and designations in the various drawings indicate like elements.

### DETAILED DESCRIPTION

In some systems, an integrated circuit may use a system cache. The system cache may be associated with lower latency, bandwidth constraints, or power consumption as compared to an off-chip memory, such as an off-chip dynamic random access memory (DRAM). Sharing such a system cache among multiple processing devices may be inefficient in some cases. For example, the processing devices may compete for access to the system cache, which may lead to poor performance in some circumstances. Further, system caches may be costly in terms of die overhead and circuit area. As a result, increasing size of the system cache may be infeasible in some scenarios.

In some aspects of the disclosure, a system cache may operate using an adaptive priority-based protocol. The system cache may be coupled to a set of producers. The producers may include, for example, one or more of a central processing unit (CPU), a graphics processing unit (GPU), a vision processing unit (VPU), or a display processing unit (DPU). Alternatively, or in addition, the producers may include processes associated with a processor, such as an encoder stage and a token generation stage that may be associated with a processor (e.g., in connection with a large language model (LLM) application). The system cache may also be coupled to a neural processing unit (NPU).

The producers may use the system cache to share (or “offload”) data for processing by the NPU. For example, in some artificial intelligence (AI) applications, a key value (KV) cache manager of the CPU may provide an updated key value to the system cache. A transformer model of the NPU may retrieve the updated key value and may store a key output to the system cache. The KV cache manager may retrieve the key output from the system cache.

In some aspects, priorities may be adaptively determined for each of the producers. The priorities may determine which data is to be evicted from the system cache. In some examples, a cache controller may determine a priority associated with a producer based on a difference between a target bandwidth (BWk) associated with processing, by the NPU, of data for the producer and a memory bandwidth (BWm) associated with storing of the data to the system cache. In some examples, the memory bandwidth may correspond to an “actual” or measured bandwidth associated with the system cache. The target bandwidth may correspond to a theoretical bandwidth to support processing operations by the NPU. The target bandwidth may also be referred to as a kernel cache bandwidth. In some examples, the target bandwidth may be based on an arithmetic intensity or a kernel arithmetic intensity (KAI) associated with processing of the data by the NPU.

In some examples, the cache controller may select, as the highest priority, the producer with the greatest magnitude of difference between the target bandwidth and the memory bandwidth. In some other examples, the cache controller may select, as the highest priority, the producer with the greatest rate of change of difference between the target bandwidth and the memory bandwidth. In some further examples, the cache controller may use another scheme to determine the priorities, such as in accordance with a proportional-integral-derivative (PID) scheme. Evicting data may include, for example, moving the data to an off-chip memory, such as an off-chip dynamic random access memory (DRAM).

By using priorities to adaptively select data for eviction from the system cache, data that is more memory intensive (or “memory-bound”) may be evicted less often than data that is more computationally intensive (or “compute-bound”), which may increase efficiency and performance. To illustrate, in some AI applications, an encoding stage may be more compute-bound than a token generation stage, which may be relatively memory-bound (e.g., due to a large KV cache size). In this example, data of the encoding stage may be subject to fewer operations and accessed less frequently than data of the token generation stage. As a result, by evicting the data of the encoding stage (or other data) instead of the data of the token generation stage, efficiency and performance may be increased.

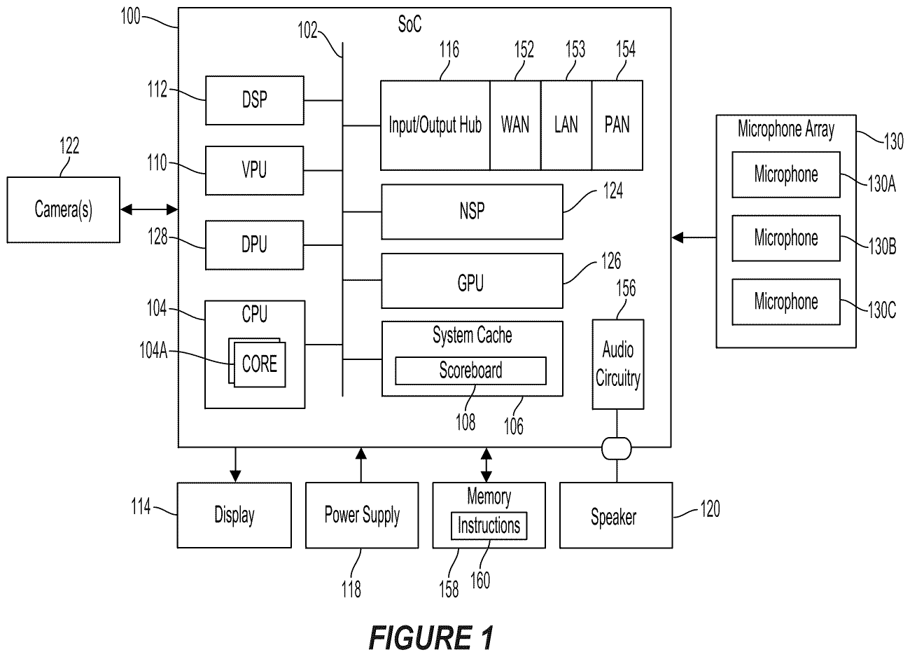

FIG. 1 is a block diagram illustrating an example of a system-on-chip (SoC) 100 that supports bandwidth-based eviction of data for a system cache, such as a system cache 106. The SoC 100 may include several components coupled together through a bus 102, which may be a network-on-a-chip (NoC) or a plurality of NoCs interconnecting various components. For example, although FIG. 1 illustrates several components coupled to the bus 102, the several components may be coupled to different busses with additional busses connecting the different busses to provide a path for communication between the components.

One example component in the SoC 100 is a digital signal processor (DSP) 112 for signal processing. The DSP 112 may process audio signals received from microphones 130A, 130B, and 130C of microphone array 130. The DSP 112 may include hardware customized for performing a set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 100 also includes a central processing unit (CPU) 104. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions retrieved from one or more memories. In some embodiments, the CPU 104 may execute an operating system may to coordinate execution of instructions by various components within the SoC 100. For example, the CPU 104 may retrieve instructions from a memory and may cause the DSP 112 to execute the instructions.

The SoC 100 may further include a neural signal processor (NSP) 124. In some examples, the NSP 124 may include or may also be referred to as an artificial intelligence (AI) processing unit (APU), an AI neural engine (ANE), a neural processing engine (NPE), or a neural processing unit (NPU). The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). In some implementations, an ANN executed by the NSP 124 may access predefined training weights for performing operations on user data.

The SoC 100 may be coupled to a display 114 for interacting with a user. The SoC 100 may also include a graphics processing unit (GPU) 126 for rendering images on the display 114. In some other implementations, the CPU 104 may perform rendering to the display 114 without use of the DPU 128. In some embodiments, the GPU 126 may be configured to execute instructions for performing operations unrelated to rendering images, such as for processing large volumes of datasets in parallel.

Alternatively, or in addition, the SoC 100 may include a display processing unit (DPU) 128. In some examples, the DPU 128 may include or may be referred to as a display engine or display controller associated with the display 114. The DPU 128 may perform operations associated with the display 114, such as scaling, color correction, and high dynamic range (HDR) processing, as illustrative examples.

In some implementations, the SoC 100 may include a vision processing unit (VPU) 110. The VPU 110 may process images, videos, or both, such as images and video captured using one or more cameras 122. In some examples, the VPU 110 may perform operations including object recognition, depth sensing, and computer vision (CV) operations.

Input/output components may be coupled to the SoC 100 through an input/output (I/O) hub 116. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 156 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 156 may include coder/decoder (CODEC) functionality for processing digital audio signals. The audio circuitry 156 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 156 and/or other processors of the SoC (e.g., CPU 104, DSP 112, GPU 126, NSP 124).

The system cache 106 may be coupled to the bus 102 and may be configured to communicate with one or more other components of the SoC 100 via the bus 102, via one or more other buses, or a combination thereof. To illustrate, the system cache 106 may be configured to store data associated with one or more of the CPU 104, the VPU 110, the DSP 112, the DPU 128, the NSP 124, or the GPU 126. The system cache 106 may be configured to operate in accordance with a scoreboard 108. Some illustrative examples of features that may be associated with the scoreboard 108 are described further below.

In some implementations, the SoC 100 may be coupled to one or more external memories, such as a memory 158. Depending on the implementation, the memory 158 may include a volatile memory, as a dynamic random access memory (DRAM). Alternatively, or in addition, the memory 158 may include a non-volatile memory, such as a flash memory.

In some examples, one or more of the system cache 106 or the memory 158 may include a non-transient or non-transitory computer readable medium storing computer-executable instructions to perform one or more operations described herein. For example, the memory 158 may store instructions 160. The instructions 160 may include a multimedia application (or other suitable application such as a messaging application) to be executed by the SoC 100 that records, processes, or outputs audio signals. The instructions 160 may also include other applications or programs executed by the SoC 100, such as an operating system and applications other than for multimedia processing.

In addition to storing instructions, one or both of the system cache 106 or the memory 158 may also store data, such as audio-related data. For example, SoC 100 may be coupled to an external memory and configured to access the memory for writing output audio files for later playback or long-term storage. To further illustrate, the SoC 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 158 for processing by the SoC 100, with the resulting signals after processing encoded as video or audio files in the memory 158 for transfer to the long-term storage.

The SoC 100 may couple to one or more other external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a limited-capacity power supply 118 such as a battery. For example, operations may be performed on a portion of the SoC 100 configured for performing the operation at a lowest power consumption. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a single SoC 100, which may include all components built on a single semiconductor die with a common semiconductor substrate, other arrangements of the illustrated blocks different number of dies, substrates, and/or packages may be arranged to accomplish the same functionality described in this disclosure.

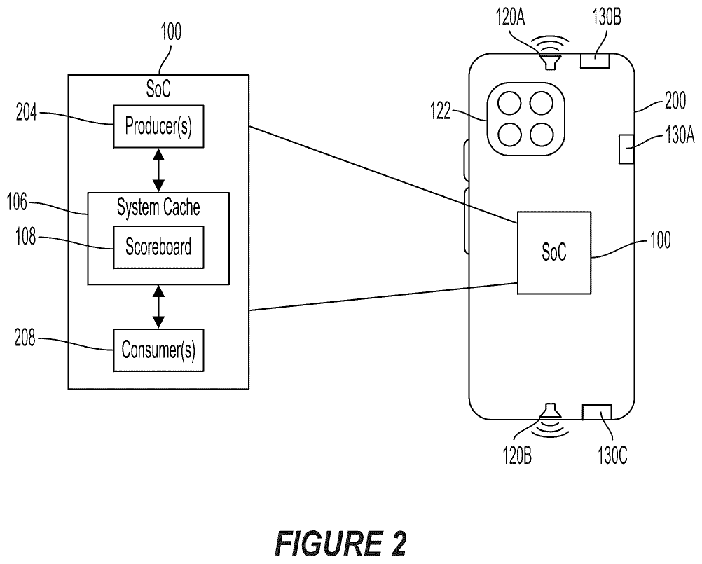

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the SoC 100. One example integration of some aspects of this disclosure into a wireless device are shown in FIG. 2.

FIG. 2 is a block diagram illustrating an example of a wireless device 200 that supports bandwidth-based eviction of data for a system cache, such as the system cache 106. The wireless device 200 may include the SoC 100 of FIG. 1. In the example of FIG. 2, the SoC 100 may further include one or more components coupled to the SOC 100, such as one or more of a speaker 120A, a speaker 120B, the microphones 130A-C, or the one or more cameras 122.

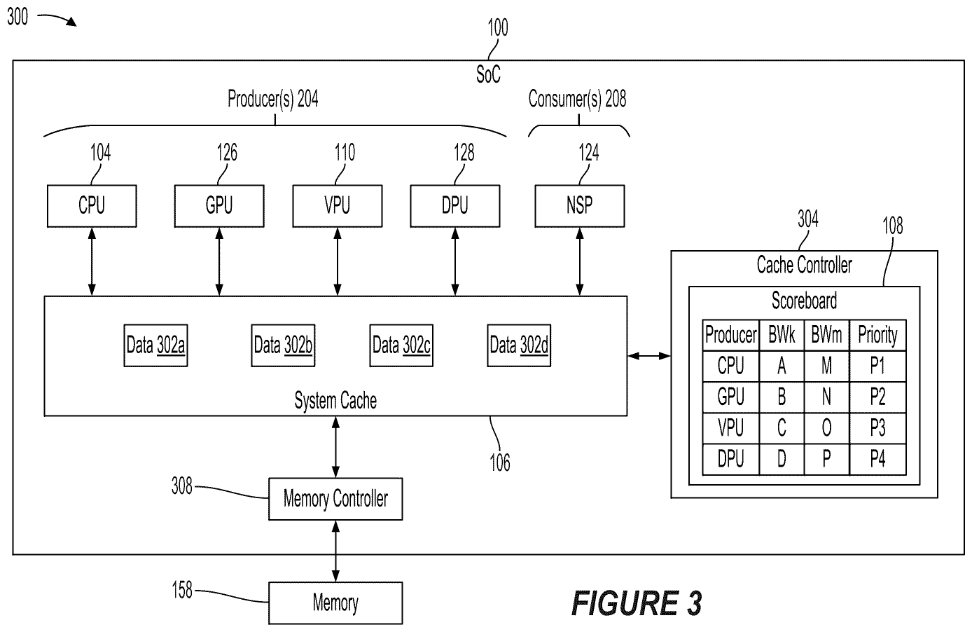

The example of FIG. 2 also illustrates that the SoC 100 may include the system cache 106 and the scoreboard 108. Further, one or more producers 204 may access (e.g., share) the system cache 106. In some examples, the one or more producers 204 may include one or more of the CPU 104, the VPU 110, the DSP 112, the DPU 128, the GPU 126, or one or more other components. Some additional examples are described further with reference to FIG. 3.

FIG. 3 is a block diagram illustrating an example of a system 300 that supports bandwidth-based eviction of data for a system cache, such as the system cache 106. The system 300 may include the SoC 100, which may include the one or more producers 204, such as one or more of the CPU 104, the GPU 126, the VPU 110, the DPU 128, or one or more other components. The system 300 may further include the one or more consumers 208. In some examples, the one or more consumers 208 may include the NSP 124.

The SoC 100 may further include the system cache 106. The system cache 106 may be coupled to the one or more producers 204 and to the one or more consumers 208.

The SoC 100 may further include a cache controller 304 associated with the system cache 106. The cache controller 304 may be coupled to or included in the system cache 106. In some implementations, the cache controller 304 may store or maintain producer-specific information for a plurality of producers. The producer-specific information may include a target bandwidth BWk associated with processing by the NSP of data for a producer and a memory bandwidth BWm associated the storing of data by a producer to a system cache. In some examples, the producer-specific information additionally indicates the difference between BWk and BWm for each producer. The producer-specific information may be presented in the form of a scoreboard 108 in one example. Other forms are also within the scope of the disclosure. For example, in some implementations, the CPU 104 may have access to information associated with the SoC 100 and may use such information to update parameters associated with the scoreboard 108. In another example, a dedicated component (e.g., a scoreboard monitor) may monitor information associated with the SoC 100 and may use such information to update parameters associated with the scoreboard 108. Alternatively, or in addition, in some implementations, a memory management unit (MMU) may monitor information associated with the SoC 100 and may use such information to update parameters associated with the scoreboard 108.

In some examples, the SoC 100 may also include a memory controller 308. The memory controller 308 may be coupled to the memory 158. In some other implementations, the memory controller 308 may be external to the SoC 100.

During operation, the one or more producers 204 may store data to the system cache 106. To illustrate, in some examples, the CPU 104, the GPU 126, the VPU 110, and the DPU 128 may store data 302a, 302b, 302c, and 302d, respectively, to the system cache 106. Further, in some examples, any of the data 302a-d may be shared among a respective producer 204 and the NSP 124. To illustrate, in some examples, the CPU 104 may send the data 302a to the system cache 106 to enable the NSP 124 to retrieve the data 302a from the system cache 106. The NSP 124 may perform processing tasks associated with the data 302a and may store the data 302a (or a processed version of the data 302a) to the system cache 106 after performing the processing tasks. In such examples, the processing tasks may be shared (or “offloaded”) from the CPU 104 to the NSP 124. Further, the data 302b, the data 302c, and the data 302d may be shared among the GPU 126, the VPU 110, and the DPU 128, respectively, with the NSP 124 via the system cache 106.

To further illustrate, in some artificial intelligence (AI) applications, the CPU 104 may include or may execute a key value (KV) cache manager. In some examples, the KV cache manager may update a key value and may provide the updated key value to the system cache 106. A transformer model of the NSP 124 may retrieve the updated key value from the system cache 106 and may store a key output to the system cache 106 based on the updated key value. The KV cache manager may retrieve the key output from the system cache 106. In such examples, generation of the key output may be shared (or “offloaded”) from the CPU 104 to the NSP 124. Further, one or more of the updated key value or the key output may be included in the data 302a.

Further, components of the system 300 may update information of the scoreboard 108. For example, the scoreboard 108 may indicate, for each producer of the one or more producers 204, a target bandwidth BWk associated with processing, by the NSP 124, of data for the producer. The target bandwidth BWk may correspond to a theoretical bandwidth to support processing of the data by the NSP 124. The target bandwidth BWk may also be referred to as a kernel cache bandwidth. In some examples, the target bandwidth may be based on an arithmetic intensity or a kernel arithmetic intensity (KAI) associated with processing of the data by the NPU. To further illustrate, in some examples, the target bandwidth BWk may be determined in accordance with Equation 1:

BWk=BWmath/KAI (Equation 1).

In Equation 1, BWmath may indicate a rate of arithmetic operations that is supported (or achievable) by the NSP 124. Further, KAI may correspond to an arithmetic intensity associated with a kernel executed by the NSP 124, such as a layer or sub-layer of the NSP 124. In some examples, KAI may correspond to ratio of a total quantity of arithmetic operations (Nop) to a total quantity of data in bytes associated with the arithmetic operations (Nbyte), such as in accordance with Equation 2:

KAI=Nop/Nbyte (Equation 2).

Further, it is noted that values of KAI may be different for each of the one or more producers 204. For example, each of the one or more producers 204 may be associated with a different respective architecture or module of an architecture of the NSP 124, which may yield different values of KAI for the same producer.

In some implementations, each of the one or more producers 204 may dynamically update the scoreboard 108 with respective values of the target bandwidth BWk. To illustrate, in the example of FIG. 3, the CPU 104, the GPU 126, the VPU 110, and the DPU 128 may update the scoreboard with values “A”, “B”, “C”, and “D”, respectively, of the target bandwidth BWk. Further, the values of the target bandwidth BWk may be determined based on processing associated with the data 302a-d, respectively. For example, the CPU 104 may determine the value “A” of the target bandwidth BWk based on processing associated with the data 302a. In this case, the CPU 104 may update the scoreboard 108 with the value “A” of the target bandwidth BWk. In connection with processing of other data, the CPU 104 may update the scoreboard 108 with another value of the target bandwidth BWk.

The example of FIG. 3 also illustrates that the scoreboard 108 may indicate, for each producer of the one or more producers 204, a memory bandwidth BWm associated with storing of the data by the producer to the system cache 106. In some examples, the memory bandwidth BWm may correspond to an “actual” or measured bandwidth associated with the system cache 106 or a data rate at which data is stored to the system cache 106.

To illustrate, in some examples, the cache controller 304 may monitor the data rates at which data (e.g., the data 302a-d) is stored to the system cache 106 and may update the scoreboard 108 with the data rates as values of the memory bandwidth BWm. To illustrate, the cache controller 304 may monitor the data rates at which the data 302a-d is stored to the system cache 106 and may update the scoreboard 108 with values “M”, “N”, “O”, and “P”, respectively, of the memory bandwidth BWm.

In some implementations, the cache controller 304 may determine, for each producer of the one or more producers 204, a priority based on the target bandwidth BWk of the producer and further based on the memory bandwidth BWm of the producer. To illustrate, in the example of FIG. 3, the CPU 104, the GPU 126, the VPU 110, and the DPU 128 may be associated with priorities “P1”, “P2”, “P3”, and “P4”. The priority associated with a producer may be based on a difference between the target bandwidth BWk of the producer and the memory bandwidth BWm of the producer.

To further illustrate, in some examples, the priority of a producer may be based on a magnitude of the difference between the target bandwidth BWk of the producer and the memory bandwidth BWm of the producer. In such examples, a larger difference between the target bandwidth BWk of the producer and the memory bandwidth BWm of the producer may result in a greater priority, and a smaller difference between the target bandwidth BWk of the producer and the memory bandwidth BWm of the producer may result in a smaller priority.

Alternatively, or in addition, in some examples, the priority of a producer may be based on a rate of change of the difference between the target bandwidth BWk of the producer and the memory bandwidth BWm of the producer. In such examples, a rate of change between the target bandwidth BWk of the producer and the memory bandwidth BWm of the producer may result in a greater priority if the rate of change indicates that the target bandwidth BWk is increasing faster than the memory bandwidth BWm, or if the rate of change indicates that the memory bandwidth BWm is decreasing faster than target bandwidth BWk. Alternatively, or in addition, rates of change in the difference between the target bandwidth BWk and the memory bandwidth BWm may be compared for multiple producers. In some such examples, a producer may be assigned a greater priority if the rate of change associated with the producer indicates that the target bandwidth BWk is increasing faster than the memory bandwidth BWm (or if the rate of change indicates that the memory bandwidth BWm is decreasing faster than target bandwidth BWk) as compared to one or more other producers.

Alternatively, or in addition, in some examples, the priority of a producer may be based on a proportional-integral-derivative (PID) scheme. The PID scheme may adjust priorities of producers using multiple controls including a proportional control, an integral control, and a derivative control. The proportional control may adjust the priority of each producer based on a current error between the target bandwidth BWk of the producer and the memory bandwidth BWm of the producer. The integral control may adjust the priority of each producer based on an accumulated past error between the target bandwidth BWk of the producer and the memory bandwidth BWm of the producer. The derivative control may adjust the priority of each producer based on predicted future errors between the target bandwidth BWk of the producer and the memory bandwidth BWm of the producer. The predicted future errors may be based on a rate of change of the difference between the target bandwidth BWk of the producer and the memory bandwidth BWm of the producer.

To further illustrate, in some examples, the PID scheme may include storing information to a memory that may be included in, or available to, the cache controller 304. The memory may store, for each producer, an indication of the accumulated past error and the current error. The cache controller 304 may predict a future error of a producer in accordance with one or more of the accumulated past error and the current error. For example, the cache controller 304 may apply a moving average to the accumulated past error and the current error (e.g., over a particular time window or over a particular quantity of error values) and may extrapolate the moving average over a future time period to predict the future error for the producer. Other examples are also within the scope of the disclosure.

In some circumstances, an amount of data stored to the system cache 106 may reach a threshold data size (e.g., a data capacity of the system cache 106). In such examples, the cache controller 304 may be configured to evict at least some of the data 302a-d stored at the system cache 106. Evicting such data may include relocating the data to the memory 158. Because the memory 158 may be slower or off-chip as compared to the system cache 106, evicting the data may reduce performance for a producer associated with the data (e.g., by increasing latency associated with retrieving the data).

In some aspects, the cache controller 304 may be configured to selectively evict some of the data 302a based on information indicated by the scoreboard 108. To illustrate, in the example of FIG. 3, if the priority P4 associated with the data 302d (and the DPU 128) is less than the priorities P1, P2, and P3 associated with the data 302a-c (and the CPU 104, the GPU 126, and the VPU 110), the cache controller 304 may evict the data 302d to the memory 158 (e.g., instead of evicting the data 302a-c). After eviction of the data 302d, one or more of the DPU 128 or the NSP 124 may access the data 302d at the memory 158 (e.g., instead of at the system cache 106).

To further illustrate, priorities indicated by the scoreboard 108 may indicate whether the producers 204 (or particular processes associated with the producers 204) are more compute-bound or memory-bound relative to one another. As an example, if the priority P1 exceeds the priorities P2, P3, and P4, then the CPU 104 may be more memory-bound as compared to the GPU 126, the VPU 110, and the DPU 128. In such examples, the priority P1 may indicate that the CPU 104 and the NSP 124 correspond to a memory-bound pair. As another example, if the priority P4 is less than the priorities P1, P2, and P3, then the DPU 128 may be more compute-bound as compared to the CPU 104, the GPU 126, and the VPU 110. In such examples, the priority P4 may indicate that the DPU 128 and the NSP 124 correspond to a compute-bound pair. In some aspects, the cache controller 304 may select data associated with a compute-bound pair for eviction from the system cache 106 instead of data associated with a memory-bound pair.

It is noted that parameters of the scoreboard 108 may change dynamically during operation. For example, during operation, one or more of a target bandwidth BWk (e.g., one or more of A, B, C, or D) or a memory bandwidth BWm (e.g., one or more of M, N, O, or P) may be dynamically changed. In such examples, the cache controller 304 may dynamically adjust a priority (e.g., one or more of the priorities P1, P2, P3, and P4) indicated by the scoreboard 108. In some examples, the cache controller 304 may dynamically adjust such a priority based on detecting one or more trigger events. In some examples, the one or more trigger events may include, for example, updating of a target bandwidth BWk, updating of a memory bandwidth BWm, or expiration of a time interval associated with reevaluating priorities indicated by the scoreboard 108.

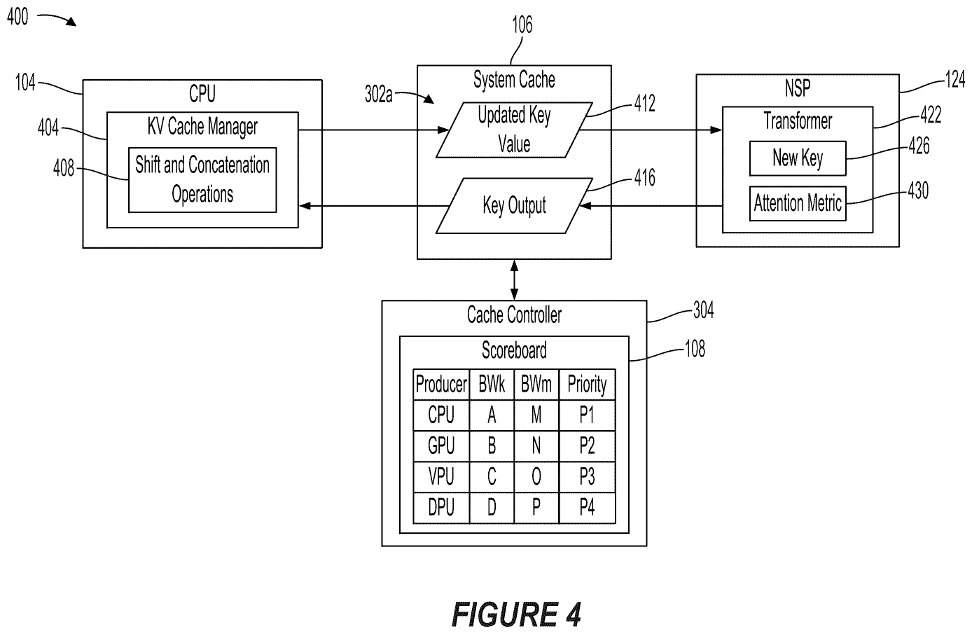

FIG. 4 is a block diagram illustrating an example of a system 400 that supports bandwidth-based eviction of data for a system cache, such as the system cache 106. In some examples, the system 400 may include one or more features of the system 300 of FIG. 3, such as one or more of the CPU 104, the system cache 106, the NSP 124, or the cache controller 304.

During operation, the CPU 104 may include or may execute a KV cache manager 404. The KV cache manager 404 may perform operations including shift and concatenation operations 408. In some examples, the KV cache manager 404 may generate an updated key value 412 and may provide the updated key value 412 to the system cache 106.

The NSP 124 may include or may execute a transformer 422. The NSP 124 may retrieve the updated key value 412 from the system cache 106 and may use the transformer 422 to process the updated key value 412, such as by generating a new key 426. In some examples, the transformer 422 may generate, output, or operate in accordance with an attention metric 430. The NSP 124 may store a key output 416 to the system cache 106. In some examples, the key output 416 may include or may correspond to the new key 426. Further, the CPU 104 may retrieve the key output 416 from the system cache 106.

In some examples, the data 302a of FIG. 3 may include one or more of the updated key value 412 or the key output 416. Further, one or more of the updated key value 412 or the key output 416 may be stored to the system cache 106 in accordance with the scoreboard 108. To illustrate, in the example of FIG. 4, the CPU 104 may be associated with a greater priority (P1) as compared to the GPU 126, the VPU 110, and the DPU 128 (which may be associated with priorities P2, P3, and P4). As a result, the cache controller 304 may avoid evicting one or more of the updated key value 412 or the key output 416 from the system cache 106.

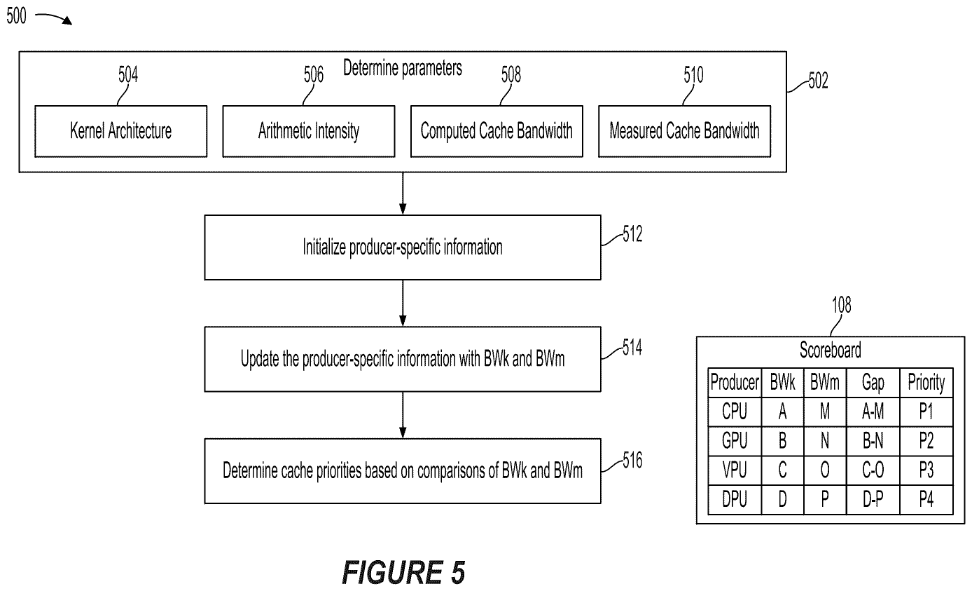

In some aspects, one or more features described herein (e.g., the features of FIG. 5) may enable or may be referred to as adaptive cache partitioning of the system cache 106. Such adaptive cache partitioning may include prioritizing data associated with a memory-bound producer so that such data is less likely to be evicted from the system cache 106 as compared to data associated with a compute-bound producer. To illustrate, data associated with an encoding process of a large language model (LLM) application may be more compute-bound as compared to a decoding process (or token generation process) of the LLM application, which may be more memory-bound. In this example, the decoding process may be associated with a greater target bandwidth (BWk) as compared to the encoding process. As a result, data associated with the decoding process may be prioritized (and may be less likely to be evicted) as compared to data associated with the encoding process. In some examples, the data associated with the decoding process may include one or more of the updated key value 412 or the key output 416.

Although some examples herein may be described with reference to an LLM application for illustration, other examples are also within the scope of the disclosure. To illustrate, in an example of a computer vision (CV) application, different processes of the CV application may be associated with different priorities. In some examples, the processes may include an optical flow estimation process, a stereo depth estimation process, an image warping process, one or more other processes, or a combination thereof. Further, each of the multiple processes may be associated with multiple sub-processes each having a different respective priority. To illustrate, the optical flow estimation process may support both a high-quality (or high-resolution) mode and a standard-quality mode, and the stereo depth estimation process may include a high frames-per-second (FPS) mode and a standard FPS mode. In some examples, the high-quality mode and the high FPS mode may be associated with greater priorities as compared to the standard-quality mode and the standard FPS mode. In addition, both the optical flow estimation process and the stereo depth estimation process may support dynamic hypothesis sampling, which may be associated with a varying sampling size (also referred to as dynamic constellation size). Each such sampling size may be associated with a different respective cache utilization and with a different respective priority indicated by the scoreboard 108. Further, some CV operations may involve dynamically changing between modes, such as from the high-quality mode and to the standard-quality mode (or vice versa), from the high FPS mode to the standard FPS mode (or vice versa), or both. Accordingly, one or more techniques described herein may facilitate effective usage of resources of the system cache 106 in connection with a variety of applications, such as LLM applications and CV applications, which may be associated with varying cache usage.

FIG. 5 is a flow chart illustrating an example of a method 500 that supports bandwidth-based eviction of data for a system cache, such as the system cache 106. In some examples, operations of the method 500 may be performed by one or more devices or systems described herein, such as by the SoC 100, wireless device 200, the system 300, or the system 400.

The method 500 may include determining parameters, at 502. The parameters may include, for example, one or more of a kernel architecture 504, an arithmetic intensity 506, a computed cache bandwidth 508, or a measured cache bandwidth 510. To further illustrate, in some examples, the kernel architecture 504 may include or may specify a kernel executed by the NSP 124, such as a layer or sub-layer of the NSP 124. The arithmetic intensity 506 may correspond to KAI of Equation 1. Further, the computed cache bandwidth 508 may correspond to the target bandwidth BWk, and the measured cache bandwidth 510 may correspond to the memory bandwidth BWm.

The method 500 may further include initializing producer-specific information, at 512, and updating the producer-specific information with the target bandwidth BWk and the memory bandwidth BWm, at 514. For example, the producer-specific information may include or more be indicated via the scoreboard 108, and the scoreboard 108 may be initialized using values of the target bandwidth BWk (e.g., A, B, C, and D) and the memory bandwidth BWm (e.g., M, N, O, and P). In some examples, the scoreboard may be initialized, updated, or both upon powerup of a device, such as the SoC 100, wireless device 200, the system 300, or the system 400.

The method 500 may further include determining cache priorities based on comparisons of the target bandwidth BWk and the memory bandwidth BWm, at 516. For example, the cache priorities may include the priorities P1, P2, P3, and P4. Further, in some implementations, the cache priorities may be based on a difference (or gap) between the target bandwidth BWk and the memory bandwidth BWm for each producer associated with the scoreboard 108. To illustrate, the differences may include a difference A-M, a difference B-N, a difference C-O, and a difference D-P. In such examples, a greater (or smaller) difference may be assigned a greater (or smaller) priority of the cache priorities.

It is noted that one or more features described herein may be used in combination with at least one other priority scheme, such as a legacy priority scheme. To illustrate, in some examples, the legacy priority scheme may include one or more of a software-based task priority scheme (e.g., where priorities may be determined at least in part based on explicit or static task priority indications set via software), a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme, as illustrative examples. In one example, the cache controller 304 may assign weights to the legacy priority scheme and differences in the target bandwidth BWk and the memory bandwidth BWm and may determine each priority (e.g., P1, P2, P3, and P4) as a weighted combination of the legacy priority scheme and the differences in the target bandwidth BWk and the memory bandwidth BWm. Further, in such examples, the cache controller 304 may be configured to evict data from the system cache 106 in accordance with the legacy priority scheme in addition to differences in the target bandwidth BWk and the memory bandwidth BWm.

Although some examples are described herein for illustration, other examples are also within the scope of the disclosure. For example, although the NSP 124 may be described as a consumer, in some other examples, the one or more consumers 208 may include one or more other consumers (alternatively or in addition to the NSP 124). Further, although some examples may be described with reference to multiple producers 204 and one consumer 208, other examples may use one producer 204, multiple consumers 208, or both. In addition, although some examples, may illustrate that each producer of the scoreboard 108 may correspond to a different processor, in some other examples, a processor may execute multiple different processes each corresponding to a different producer associated with the scoreboard 108.

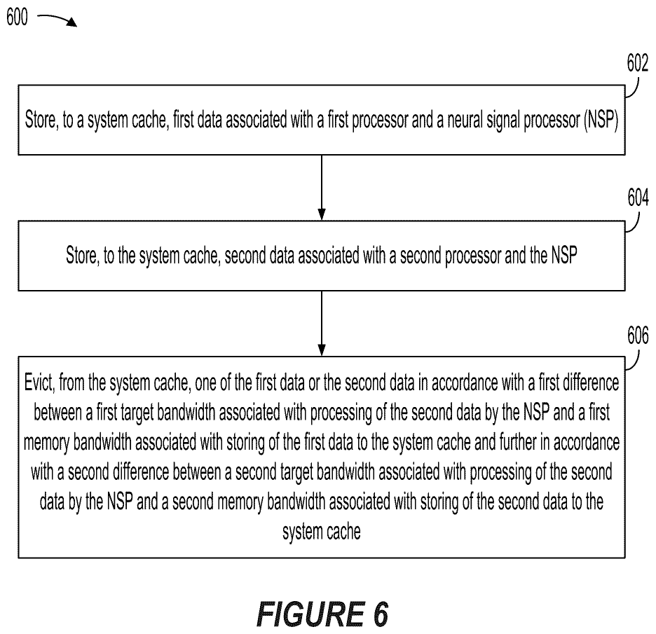

FIG. 6 is a flow chart illustrating an example of a method 600 that supports bandwidth-based eviction of data for a system cache. In some examples, operations of the method 600 may be performed by the cache controller 304 in conjunction with the system cache 106.

The method 600 includes storing, to a system cache, first data associated with a first producer and a neural signal processor (NSP), at 602. For example, the cache controller 304 may store any of the data 302a-d to the system cache 106. In some examples, the first producer may correspond to one of the producers 204, and the NSP may correspond to the NSP 124.

The method 600 further includes storing, to the system cache, second data associated with a second producer and the NSP, at 604. For example, the cache controller 304 may store other data of the data 302a-d to the system cache 106. In some examples, the second producer may correspond to another of the producers 204.

The method 600 further includes evicting, from the system cache, one of the first data or the second data, at 606. The one of the first data or the second data is evicted in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache. In some examples, the first target bandwidth may correspond to one of the target bandwidths (BWk) indicated by the scoreboard 108 (such as one of A, B, C, or D), and the second target bandwidth may correspond to another of the target bandwidths (BWk) indicated by the scoreboard 108 (such as another of A, B, C, or D). In some examples, the first memory bandwidth may correspond to one of the memory bandwidths (BWm) indicated by the scoreboard 108 (such as one of M, N, O, or P), and the second memory bandwidth may correspond to another of the memory bandwidths (BWm) indicated by the scoreboard 108 (such as another of M, N, O, or P). In some examples, the first difference may correspond to one of the difference A-M, the difference B-N, the difference C-O, or the difference D-P of FIG. 5, and the second difference may correspond to another of the difference A-M, the difference B-N, the difference C-O, or the difference D-P of FIG. 5.

The method 600 may further include determining updated parameters and evicting data from, or maintaining data at, the system cache 106 in accordance with the updated parameters. For example, the cache controller 304 may determine an updated first difference between the first target bandwidth and the first memory bandwidth and may determine an updated second difference between the second target bandwidth and the second memory bandwidth. The cache controller 304 may evict data from the system cache 106 in accordance with the updated first difference and the updated second difference, such as by evicting the other of the first data or the second data (or third data) in accordance with the updated first difference and the updated second difference. In some examples, the first producer may be associated with a first priority (such as one of P1, P2, P3, or P4) based on the first difference and the second producer may be associated with a second priority (such as another of P1, P2, P3, or P4) based on the second difference. The cache controller 304 may evict the other of the first data or the second data (or the third data) in accordance with the updated first difference and the updated second difference, such as by evicting the other of the first data or the second data (or the third data) based on one or more of an updated first priority associated with the updated first difference or an updated second priority associated with the updated second difference. In some examples, the updated first priority and the updated second priority may be less than one or more other priorities, resulting in eviction of the other of the first data or the second data. Accordingly, priorities of producers may be determined and modified dynamically during operation, and data may be dynamically evicted from, or maintained at, the system cache 106 in accordance with such priorities.

One or more features herein may improve operation of a device that uses a system cache, such as the system cache 106. For example, by using priorities to adaptively select data for eviction from the system cache 106, data that is more memory intensive (or “memory-bound”) may be evicted less often than data that is more computationally intensive (or “compute-bound”), which may increase efficiency and performance. As an illustrative example, in some AI applications, an encoding stage may be more compute-bound than a token generation stage, which may be relatively memory-bound (e.g., due to a large KV cache size). In this example, data of the encoding stage may be subject to fewer operations and accessed less frequently than data of the token generation stage. As a result, by evicting the data of the encoding stage (or other data) instead of the data of the token generation stage, efficiency and performance may be increased.

In a first aspect, an apparatus includes a system cache and a cache controller coupled to the system cache. The system cache is configured to store first data associated with a first producer and a neural signal processor (NSP). The system cache is further configured to store second data associated with a second producer and the NSP. The cache controller is configured to evict one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

In a second aspect, in combination with the first aspect, the cache controller is further configured to evict the one of the first data or the second data based on a comparison of a first magnitude of the first difference and a second magnitude of the second difference.

In a third aspect, in combination with one or more of the first aspect or the second aspect, the cache controller is further configured to evict the one of the first data or the second data based on one or more of a first rate of change of the first difference, a second rate of change of the second difference, or a comparison of the first rate of change and the second rate of change.

In a fourth aspect, in combination with one or more of the first aspect through the third aspect, the cache controller is further configured to evict the one of the first data or the second data based on a proportional-integral-derivative (PID) scheme that specifies, for each producer of a plurality of producers including the first producer and the second producer, a current error between a target bandwidth of the producer and a memory bandwidth of the producer, an accumulated past error between the target bandwidth and the memory bandwidth, and a predicted future error between the target bandwidth and the memory bandwidth.

In a fifth aspect, in combination with one or more of the first aspect through the fourth aspect, the first producer is associated with a first priority based on the first difference, the second producer is associated with a second priority based on the second difference, and the cache controller is further configured to evict the second data, instead of the first data, to an off-chip memory based on the first priority exceeding the second priority.

In a sixth aspect, in combination with one or more of the first aspect through the fifth aspect, the cache controller is further configured to determine an updated first difference between the first target bandwidth and the first memory bandwidth, to determine an updated second difference between the second target bandwidth and the second memory bandwidth, and to evict the other of the first data or the second data in accordance with the updated first difference and the updated second difference.

In a seventh aspect, in combination with one or more of the first aspect through the sixth aspect, the first producer is associated with a first priority based on the first difference and the second producer is associated with a second priority based on the second difference, and the cache controller is further configured to evict the other of the first data or the second data further in accordance with one or more of an updated first priority associated with the updated first difference or an updated second priority associated with the updated second difference.

In an eighth aspect, in combination with one or more of the first aspect through the seventh aspect, the first memory bandwidth is based on a first data rate at which the first data is provided to the NSP, and the second memory bandwidth is based on a second data rate at which the second data is provided to the NSP.

In a ninth aspect, in combination with one or more of the first aspect through the eighth aspect, the cache controller is further configured to access a scoreboard to determine the first difference and the second difference.

In a tenth aspect, in combination with one or more of the first aspect through the ninth aspect, the cache controller is further configured to evict the one of the first data or the second data from the system cache further in accordance with at least one other priority scheme that is in addition to the first difference and the second difference, and the at least one other priority scheme includes one or more of a software-based task priority scheme, a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme.

In an eleventh aspect, a method of operating a cache controller includes storing, to a system cache, first data associated with a first producer and a neural signal processor (NSP). The method further includes storing, to the system cache, second data associated with a second producer and the NSP. The method further includes evicting, from the system cache, one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

In a twelfth aspect, in combination with the eleventh aspect, the method further includes performing a comparison of a first magnitude of the first difference and a second magnitude of the second difference and evicting the one of the first data or the second data based on the comparison.

In a thirteenth aspect, in combination with one or more of the eleventh aspect through the twelfth aspect, the method further includes determining one or more of a first rate of change of the first difference, a second rate of change of the second difference, or a comparison of the first rate of change and the second rate of change, and evicting the one of the first data or the second data based on one or more of the first rate of change, the second rate of change, or the comparison.

In a fourteenth aspect, in combination with one or more of the eleventh aspect through the thirteenth aspect, the method further includes evicting the one of the first data or the second data based on a proportional-integral-derivative (PID) scheme that specifies, for each producer of a plurality of producers including the first producer and the second producer, a current error between a target bandwidth of the producer and a memory bandwidth of the producer, an accumulated past error between the target bandwidth and the memory bandwidth, and a predicted future error between the target bandwidth and the memory bandwidth.

In a fifteenth aspect, in combination with one or more of the eleventh aspect through the fourteenth aspect, the first producer is associated with a first priority based on the first difference, the second producer is associated with a second priority based on the second difference, and the method further includes evicting the second data, instead of the first data, to an off-chip memory based on the first priority exceeding the second priority.

In a sixteenth aspect, in combination with one or more of the eleventh aspect through the fifteenth aspect, the method further includes determining an updated first difference between the first target bandwidth and the first memory bandwidth, determining an updated second difference between the second target bandwidth and the second memory bandwidth, and evicting the other of the first data or the second data in accordance with the updated first difference and the updated second difference.

In a seventeenth aspect, the first producer is associated with a first priority based on the first difference and the second producer is associated with a second priority based on the second difference, and the other of the first data or the second data is evicted further in accordance with one or more of an updated first priority associated with the updated first difference or an updated second priority associated with the updated second difference.

In an eighteenth aspect, in combination with one or more of the eleventh aspect through the seventeenth aspect, the first memory bandwidth is based on a first data rate at which the first data is provided to the NSP, and the second memory bandwidth is based on a second data rate at which the second data is provided to the NSP.

In a nineteenth aspect, in combination with one or more of the eleventh aspect through the eighteenth aspect, the method further includes accessing a scoreboard to determine the first difference and the second difference.

In a twentieth aspect, in combination with one or more of the eleventh aspect through the nineteenth aspect, the method further includes evicting the one of the first data or the second data from the system cache further in accordance with at least one other priority scheme that is in addition to the first difference and the second difference, and the at least one other priority scheme includes one or more of a software-based task priority scheme, a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme.

In a twenty-first aspect, a non-transitory computer-readable medium stores instructions executable by one or more processors to initiate, perform, or control operations associated with a cache controller. The operations include storing, to a system cache, first data associated with a first producer and a neural signal processor (NSP). The operations further include storing, to the system cache, second data associated with a second producer and the NSP. The operations further include evicting one of the first data or the second data in accordance with a first difference between a first target bandwidth associated with processing of the first data by the NSP and a first memory bandwidth associated with storing of the first data to the system cache and further in accordance with a second difference between a second target bandwidth associated with processing of the second data by the NSP and a second memory bandwidth associated with storing of the second data to the system cache.

In a twenty-second aspect, in combination with the twenty-first aspect, the operations further include performing a comparison of a first magnitude of the first difference and a second magnitude of the second difference, and evicting the one of the first data or the second data based on the comparison.

In a twenty-third aspect, in combination with one or more of the twenty-first aspect through the twenty-second aspect, the operations further include determining one or more of a first rate of change of the first difference, a second rate of change of the second difference, or a comparison of the first rate of change and the second rate of change, and evicting the one of the first data or the second data based on one or more of the first rate of change, the second rate of change, or the comparison.

In a twenty-fourth aspect, in combination with one or more of the twenty-first aspect through the twenty-third aspect, the operations further include evicting the one of the first data or the second data based on a proportional-integral-derivative (PID) scheme that specifies, for each producer of a plurality of producers including the first producer and the second producer, a current error between a target bandwidth of the producer and a memory bandwidth of the producer, an accumulated past error between the target bandwidth and the memory bandwidth, and a predicted future error between the target bandwidth and the memory bandwidth.

In a twenty-fifth aspect, in combination with one or more of the twenty-first aspect through the twenty-fourth aspect, the first producer is associated with a first priority based on the first difference, the second producer is associated with a second priority based on the second difference, and the operations further include evicting the second data, instead of the first data, to an off-chip memory based on the first priority exceeding the second priority.

In a twenty-sixth aspect, in combination with one or more of the twenty-first aspect through the twenty-fifth aspect, the operations further include determining an updated first difference between the first target bandwidth and the first memory bandwidth, determining an updated second difference between the second target bandwidth and the second memory bandwidth, and evicting the other of the first data or the second data in accordance with the updated first difference and the updated second difference.

In a twenty-seventh aspect, in combination with one or more of the twenty-first aspect through the twenty-sixth aspect, the first producer is associated with a first priority based on the first difference and the second producer is associated with a second priority based on the second difference, and the other of the first data or the second data is evicted further in accordance with one or more of an updated first priority associated with the updated first difference or an updated second priority associated with the updated second difference.

In a twenty-eighth aspect, in combination with one or more of the twenty-first aspect through the twenty-seventh aspect, the first memory bandwidth is based on a first data rate at which the first data is provided to the NSP, and the second memory bandwidth is based on a second data rate at which the second data is provided to the NSP.

In a twenty-ninth aspect, in combination with one or more of the twenty-first aspect through the twenty-eighth aspect, the operations further include accessing a scoreboard to determine the first difference and the second difference.

In a thirtieth aspect, in combination with one or more of the twenty-first aspect through the twenty-ninth aspect, the cache controller evicts the one of the first data or the second data from the system cache further in accordance with at least one other priority scheme that is in addition to the first difference and the second difference, and the at least one other priority scheme includes one or more of a software-based task priority scheme, a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme.

In the figures, a single block may be described as performing a function or functions: The function or functions performed by that block may be performed in a single component or across multiple components, and/or may be performed using hardware, software, or a combination of hardware and software. To illustrate, various illustrative components, blocks, modules, circuits, and operations may be described in terms of functionality. Whether such functionality is implemented as hardware or software may depend upon the particular application and the overall system design. Skilled artisans may implement the described functionality in varying ways for each particular application, but such implementation decisions should not be interpreted as causing a departure from the scope of the disclosure. Also, the example devices may include components other than those shown, including components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or process disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
a system cache configured to store first data associated with a first producer and a neural signal processor (NSP) and further configured to store second data associated with a second producer and the NSP; and
a cache controller coupled to the system cache, the cache controller configured to evict one of the first data or the second data in accordance with:
a first difference between a first target bandwidth associated with processing of the first data by the NSP and a first memory bandwidth associated with storing of the first data to the system cache; and
a second difference between a second target bandwidth associated with processing of the second data by the NSP and a second memory bandwidth associated with storing of the second data to the system cache.

2. The apparatus of claim 1, wherein the cache controller is further configured to evict the one of the first data or the second data based on a comparison of a first magnitude of the first difference and a second magnitude of the second difference.

3. The apparatus of claim 1, wherein the cache controller is further configured to evict the one of the first data or the second data based on one or more of a first rate of change of the first difference, a second rate of change of the second difference, or a comparison of the first rate of change and the second rate of change.

4. The apparatus of claim 1, wherein the cache controller is further configured to evict the one of the first data or the second data based on a proportional-integral-derivative (PID) scheme that specifies, for each producer of a plurality of producers including the first producer and the second producer, a current error between a target bandwidth of the producer and a memory bandwidth of the producer, an accumulated past error between the target bandwidth and the memory bandwidth, and a predicted future error between the target bandwidth and the memory bandwidth.

5. The apparatus of claim 1, wherein the first producer is associated with a first priority based on the first difference, wherein the second producer is associated with a second priority based on the second difference, and wherein the cache controller is further configured to evict the second data, instead of the first data, to an off-chip memory based on the first priority exceeding the second priority.

6. The apparatus of claim 1, wherein the cache controller is further configured to:
determine an updated first difference between the first target bandwidth and the first memory bandwidth;
determine an updated second difference between the second target bandwidth and the second memory bandwidth; and
evict the other of the first data or the second data in accordance with the updated first difference and the updated second difference.

7. The apparatus of claim 6, wherein the first producer is associated with a first priority based on the first difference and the second producer is associated with a second priority based on the second difference, and wherein the cache controller is further configured to evict the other of the first data or the second data further in accordance with one or more of an updated first priority associated with the updated first difference or an updated second priority associated with the updated second difference.

8. The apparatus of claim 1, wherein the first memory bandwidth is based on a first data rate at which the first data is provided to the NSP, and wherein the second memory bandwidth is based on a second data rate at which the second data is provided to the NSP.

9. The apparatus of claim 1, wherein the cache controller is further configured to access a scoreboard to determine the first difference and the second difference.

10. The apparatus of claim 1, wherein the cache controller is further configured to evict the one of the first data or the second data from the system cache further in accordance with at least one other priority scheme that is in addition to the first difference and the second difference, and wherein the at least one other priority scheme includes one or more of a software-based task priority scheme, a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme.

11. A method of operating a cache controller, the method comprising:
storing, to a system cache, first data associated with a first producer and a neural signal processor (NSP);
storing, to the system cache, second data associated with a second producer and the NSP; and
evicting, from the system cache, one of the first data or the second data in accordance with:
a first difference between a first target bandwidth associated with processing of the first data by the NSP and a first memory bandwidth associated with storing of the first data to the system cache; and
a second difference between a second target bandwidth associated with processing of the second data by the NSP and a second memory bandwidth associated with storing of the second data to the system cache.

12. The method of claim 11, further comprising:
performing a comparison of a first magnitude of the first difference and a second magnitude of the second difference; and
evicting the one of the first data or the second data based on the comparison.

13. The method of claim 11, further comprising:
determining one or more of a first rate of change of the first difference, a second rate of change of the second difference, or a comparison of the first rate of change and the second rate of change; and
evicting the one of the first data or the second data based on one or more of the first rate of change, the second rate of change, or the comparison.

14. The method of claim 11, further comprising:
evicting the one of the first data or the second data based on a proportional-integral-derivative (PID) scheme that specifies, for each producer of a plurality of producers including the first producer and the second producer, a current error between a target bandwidth of the producer and a memory bandwidth of the producer, an accumulated past error between the target bandwidth and the memory bandwidth, and a predicted future error between the target bandwidth and the memory bandwidth.

15. The method of claim 11, wherein the first producer is associated with a first priority based on the first difference, wherein the second producer is associated with a second priority based on the second difference, and further comprising:
evicting the second data, instead of the first data, to an off-chip memory based on the first priority exceeding the second priority.

16. The method of claim 11, further comprising:
determining an updated first difference between the first target bandwidth and the first memory bandwidth;
determining an updated second difference between the second target bandwidth and the second memory bandwidth; and
evicting the other of the first data or the second data in accordance with the updated first difference and the updated second difference.

17. The method of claim 16, wherein the first producer is associated with a first priority based on the first difference and the second producer is associated with a second priority based on the second difference, and wherein the other of the first data or the second data is evicted further in accordance with one or more of an updated first priority associated with the updated first difference or an updated second priority associated with the updated second difference.

18. The method of claim 11, wherein the first memory bandwidth is based on a first data rate at which the first data is provided to the NSP, and wherein the second memory bandwidth is based on a second data rate at which the second data is provided to the NSP.

19. The method of claim 11, further comprising:
accessing a scoreboard to determine the first difference and the second difference.

20. The method of claim 11, further comprising:
evicting the one of the first data or the second data from the system cache further in accordance with at least one other priority scheme that is in addition to the first difference and the second difference, and wherein the at least one other priority scheme includes one or more of a software-based task priority scheme, a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme.

21. A non-transitory computer-readable medium storing instructions executable by one or more processors to initiate, perform, or control operations associated with a cache controller, the operations comprising:
storing, to a system cache, first data associated with a first producer and a neural signal processor (NSP);
storing, to the system cache, second data associated with a second producer and the NSP; and
evicting one of the first data or the second data in accordance with:
a first difference between a first target bandwidth associated with processing of the first data by the NSP and a first memory bandwidth associated with storing of the first data to the system cache; and
a second difference between a second target bandwidth associated with processing of the second data by the NSP and a second memory bandwidth associated with storing of the second data to the system cache.

22. The non-transitory computer-readable medium of claim 21, wherein the operations further comprise:
performing a comparison of a first magnitude of the first difference and a second magnitude of the second difference; and
evicting the one of the first data or the second data based on the comparison.

23. The non-transitory computer-readable medium of claim 21, wherein the operations further comprise:
determining one or more of a first rate of change of the first difference, a second rate of change of the second difference, or a comparison of the first rate of change and the second rate of change; and
evicting the one of the first data or the second data based on one or more of the first rate of change, the second rate of change, or the comparison.

24. The non-transitory computer-readable medium of claim 21, wherein the operations further comprise evicting the one of the first data or the second data based on a proportional-integral-derivative (PID) scheme that specifies, for each producer of a plurality of producers including the first producer and the second producer, a current error between a target bandwidth of the producer and a memory bandwidth of the producer, an accumulated past error between the target bandwidth and the memory bandwidth, and a predicted future error between the target bandwidth and the memory bandwidth.

25. The non-transitory computer-readable medium of claim 21, wherein the first producer is associated with a first priority based on the first difference, wherein the second producer is associated with a second priority based on the second difference, and wherein the operations further comprise evicting the second data, instead of the first data, to an off-chip memory based on the first priority exceeding the second priority.

26. The non-transitory computer-readable medium of claim 21, wherein the operations further comprise:
determining an updated first difference between the first target bandwidth and the first memory bandwidth;
determining an updated second difference between the second target bandwidth and the second memory bandwidth; and
evicting the other of the first data or the second data in accordance with the updated first difference and the updated second difference.

27. The non-transitory computer-readable medium of claim 26, wherein the first producer is associated with a first priority based on the first difference and the second producer is associated with a second priority based on the second difference, and wherein the other of the first data or the second data is evicted further in accordance with one or more of an updated first priority associated with the updated first difference or an updated second priority associated with the updated second difference.

28. The non-transitory computer-readable medium of claim 21, wherein the first memory bandwidth is based on a first data rate at which the first data is provided to the NSP, and wherein the second memory bandwidth is based on a second data rate at which the second data is provided to the NSP.

29. The non-transitory computer-readable medium of claim 21, wherein the operations further comprise accessing a scoreboard to determine the first difference and the second difference.

30. The non-transitory computer-readable medium of claim 21, wherein the cache controller evicts the one of the first data or the second data from the system cache further in accordance with at least one other priority scheme that is in addition to the first difference and the second difference, and wherein the at least one other priority scheme includes one or more of a software-based task priority scheme, a least-recently used (LRU) priority scheme, a least-frequently used (LFU) priority scheme, a first-in, first-out (FIFO) priority scheme, a random replacement (RR) priority scheme, a most-recently used (MRU) priority scheme, a most-frequently used (MFU) priority scheme, or a time-to-live (TTL) priority scheme.
